(19) United States
(12) Patent Application Publication
(10) Pub. No.: US 2003/0123723 A1
(43) Pub. Date: Jul. 3, 2003

(54) Automatic optimized scanning with color characterization data

(76) Inventors: Henry M. D'Souza, Cypress, TX (US); Christopher D. Voltz, Houston, TX (US); Gokalp Bayramoglu, Houston, TX (US)

Correspondence Address: AKIN, GUMP, STRAUSS, HAUER & FELD, 711 LOUISIANA STREET, SUITE 1900 SOUTH, HOUSTON, TX, 77002, US

(21) Appl. No.: 10/038,758

(22) Filed: Dec. 31, 2001

(51) Int. Cl. G06K 9/00

(52) U.S. Cl. 382/162

(57) ABSTRACT

A computer system and a non-professional scanner provide automatic optimized scanning utilizing a scanner specific color profile. The profile may be pre-built and pre-stored in the scanner by the scanner manufacturer. Alternatively, a scanner specific color profile may be built with each scanning cycle of the scanner. Along with an image, a color reference swatch, whether part of a target sheet or embedded in a bed of the scanner, may be scanned each cycle to produce the scanner specific color profile.

### SPECIFICATION

### CROSS-REFERENCE TO RELATED APPLICATIONS

Not Applicable.

### STATEMENTS REGARDING FEDERALLY SPONSORED RESEARCH OR DEVELOPMENT

Not Applicable.

### REFERENCE TO A MICROFICHE APPENDIX

Not Applicable.

### BACKGROUND OF THE INVENTION

1. Field of the Invention

The present invention generally relates to color optimization for scanners and more particularly to automatic optimized scanning with color characterization data.

2. Description of the Related Art

Scanners for consumers today are available in optical resolutions up to 1200×600 dpi and color depths of 42 bpp. These scanners are increasingly being used for color applications such as scanning color photographs. A displayed image generally does not match the colors of the original image scanned. When the same image is printed, the colors of the image look different in yet another way.

Non-professional or low-end scanners typically rely upon a generic color profile for color management. Such a profile has been built based on the characterization of a number of scanner units as part of a qualification or testing process. The generic color profile thus represents the average color characteristics for scanners actually characterized. Due to manufacturing variations, a generic profile is generally not a good match for any specific scanner. In fact, the result of applying the generic profile to a specific scanner is often a shift in the white point and a shift of the hues of the image.

For professional or high-end scanners, specialized software and an associated test scan image have been utilized to generate a scanner specific profile. Since this type of solution is very expensive (typically thousands of dollars), requires a trained operator who understands color science to a certain degree, and requires the operator to periodically repeat the process to keep the scanner in calibration, this action is not viable for typical consumers.

### BRIEF SUMMARY OF THE INVENTION

Briefly, a computer system and a non-professional scanner provide automatic optimized scanning utilizing a scanner specific color profile. The profile may be pre-built and pre-stored in the scanner by the scanner manufacturer. Alternatively, a scanner specific color profile may be built with each scanning cycle of the scanner. Along with an image, a color reference swatch, whether part of a target sheet or embedded in a bed of the scanner, may be scanned each cycle to produce the scanner specific color profile.

### BRIEF DESCRIPTION OF THE SEVERAL VIEWS OF THE DRAWINGS

A better understanding of the present invention can be obtained when the following detailed description of the invention is considered in conjunction with the following drawings in which:

FIG. 1 is a block diagram of an exemplary technique of employing a color reference swatch to build a scanner specific color profile for a scanner at the scanner factory;

FIG. 2 is a block diagram of an exemplary technique of color management for a scanner utilizing the scanner specific color profile of FIG. 1;

FIG. 3 is a block diagram of an exemplary technique of automatically employing a color reference swatch in building a scanner specific color profile with each scanning cycle of a scanner; and

FIG. 4 is an illustration of an exemplary scanner bed depicting a color reference swatch and an image scan area.

### DETAILED DESCRIPTION OF THE INVENTION

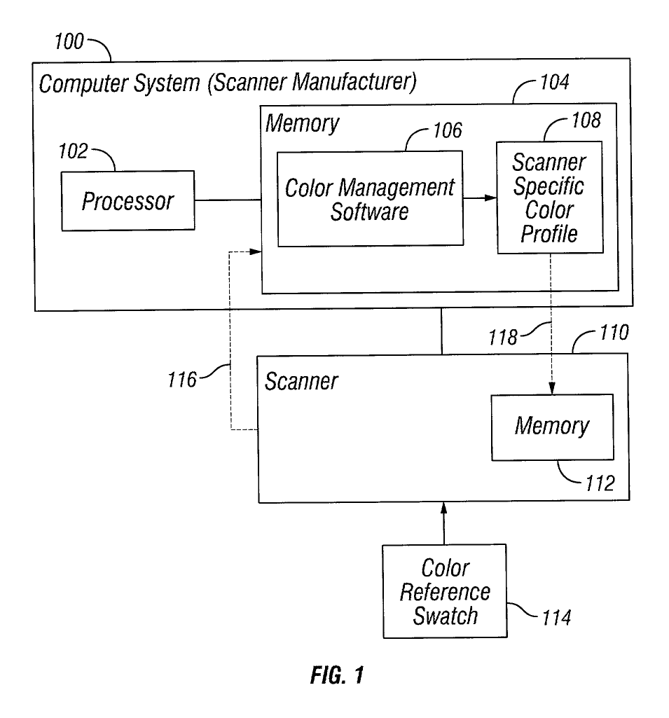

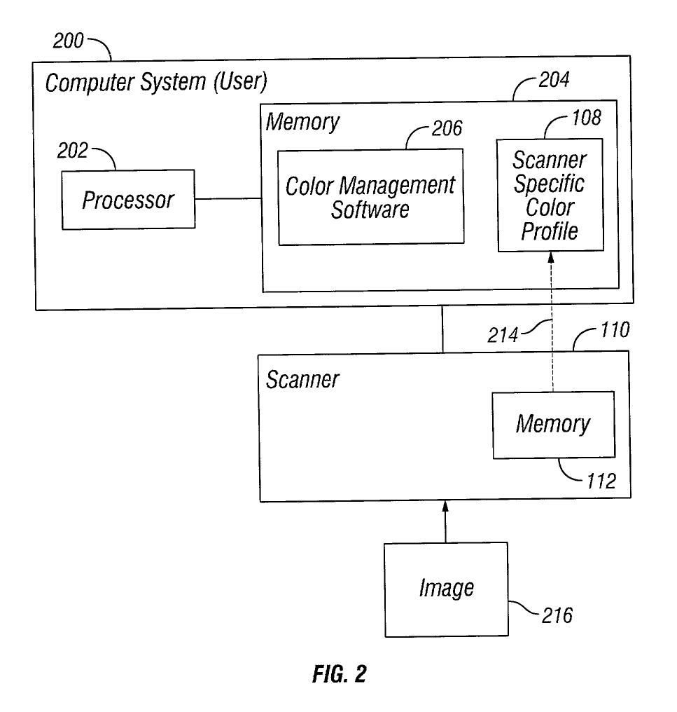

Referring to FIG. 1, an exemplary technique of building a scanner specific color profile for a non-professional scanner directly at a scanner factory is shown. A factory computer system 100 of the scanner manufacturer includes a processor 102 coupled to a memory 104. Initially contained in the memory 104 is color management software 106. Certain typical components of a computer system are omitted from FIG. 2 for sake of clarity. The computer system 100 is connected to a scanner 110. A color reference swatch 114 is scanned by the scanner 110. A CMYK (cyan/magenta/yellow/black) color swatch, an industry-standard IT8 scanner target or any other swatch containing primary colors is suitable for the color reference swatch 114. The color data 116 captured by the scan is provided to the color management software 106. Based on the color data 116, the color management software 106 creates a scanner specific color profile 108 for the scanner 110. The scanner specific color profile 108 is then stored in a memory 112 of the scanner 110.

Referring to FIG. 2, an exemplary technique of color management for the scanner 110 utilizing the scanner specific color profile 108 is shown. The scanner specific color profile 108, which represents color characterization data for the scanner 110, is copied from the scanner memory 112 to a memory 204 of a computer system 200 of a user. The memory 204 further includes color management software 206 executable by a processor 202. Following a scan of an image 216 by the scanner 110, the color management software 206 automatically utilizes the scanner specific color profile 108 to perform color correction or optimization for the image 216. Color correction generally refers to rendering consistent or perceptually uniform color for images. Such color correction may involve matrix operations, filtering and/or look-up tables to map or convert colors of the image 216 to a standard or known color space such as sRGB. An advantage of the techniques described in FIGS. 1-2 is that no user or consumer intervention is needed to build the scanner specific color profile 108 or to perform color correction based on the scanner specific color profile 108. The scanner specific color profile 108 is effectively pre-built and pre-stored by the scanner manufacturer.

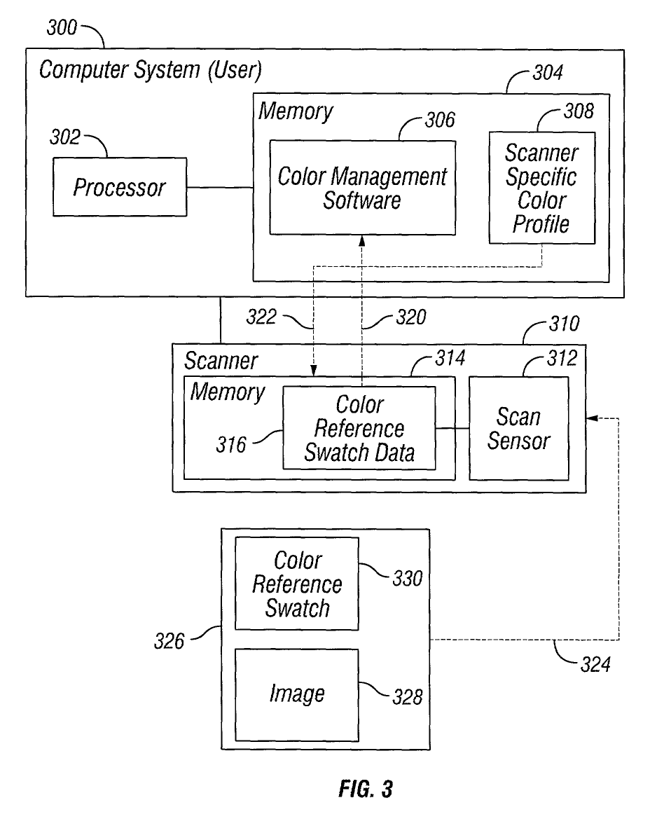

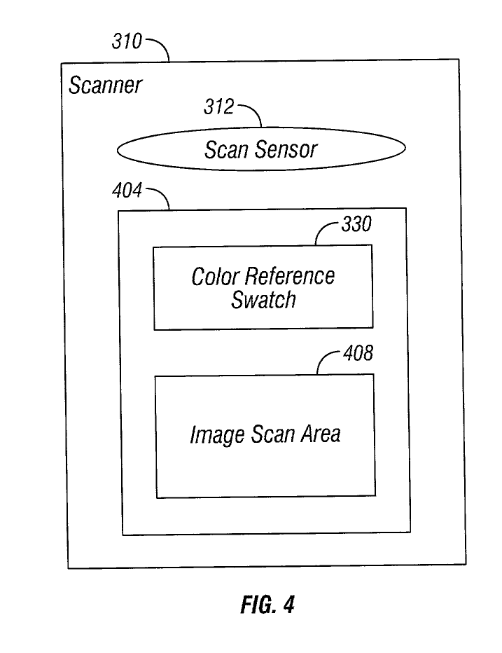

Referring to FIG. 3, an exemplary technique of automatically employing a color reference swatch 330 in building a scanner specific color profile 308 with each scanning cycle of a non-professional scanner 310 is shown. A target sheet 326 contains the color reference swatch 330 and an image 328. When the target sheet 326 is scanned by the scanner 310, the scan sensor 312 detects both the color reference swatch 330 and the image 328. In an alternative embodiment as represented in FIG. 4, the color reference swatch 330 is instead embedded in a bed of the flatbed scanner 310. The scan sensor 312 is configured to detect both the embedded color reference swatch 330 and any image in an image scan area 408 of the scan area 404 of the scanner bed. If the scan sensor 312 was previously designed to accommodate only image scan area 408, then the range of the scan sensor 312 should be extended. With this approach, the size of the total scan area 404 is increased to incorporate the color reference swatch 330.

Returning to FIG. 3, color reference swatch data 316 captured by the scan sensor 312 is stored in a memory 314 of the scanner 310. As represented by the dashed line 320, the color reference swatch data 316 is provided to color management or correction software 306 stored in a memory 304 of a computer system 300 of a user. The color management software may be part of an operating system or alternatively may be a distinct application. Microsoft Windows® 98 and 2000, for instance, contain support for ICC (International Color Consortium) profiles in the form of Integrated Color Management (ICM) 2.0 APIs (application programming interfaces). The computer system 300 is of a similar configuration to that shown in FIG. 2. The computer system 300 includes a processor 302 to execute the color management software 306. Based on the color reference swatch data 316, the color management software 306 builds a scanner specific color profile 308. As represented by dashed line 322, the scanner specific color profile 308 is stored in the memory 314 of the scanner. The color management software 306 performs color correction for the image 328 based on the scanner specific color profile 308. With this approach, a scanner specific color profile 308 is built with each scanning cycle of the scanner 310. The scanner 310 thus is self color-calibrated on every scan. One advantage of this approach is that illuminant changes over time would not render a color profile a poor or unsuitable match.

The foregoing disclosure and description of the various embodiments are illustrative and explanatory thereof, and various changes in the storage techniques, scanning techniques, color profiles, color management software, color swatches, components, circuit elements, circuit configurations, and signal connections, as well as in the details of the illustrated circuitry and software and construction and method of operation may be made without departing from the spirit and scope of the invention.

We claim:

1. A method, comprising the steps of:
pre-scanning a color reference swatch with a scanner to produce color reference data for the scanner;
pre-building a scanner specific color profile for the scanner based on the color reference data; and
pre-storing the scanner specific color profile in the scanner.

2. The method of claim 1, wherein the pre-scanning, pre-building and pre-storing steps are performed by color management software of a manufacturer of the scanner.

3. The method of claim 1, wherein the scanner comprises a non-professional scanner.

4. The method of claim 1, further comprising the step of:
automatically performing color correction for the scanner based on the scanner specific color profile.

5. The method of claim 4, wherein the performing step occurs with each scanning cycle of the scanner.

6. The method of claim 1, wherein the color reference swatch comprises a CMYK swatch.

7. A method, comprising the steps of:
scanning a color reference swatch and an image during a scanning cycle of scanner to produce color swatch reference data and image data;
building a scanner specific color profile based on the color reference swatch data; and
storing the scanner specific color profile in the scanner.

8. The method of claim 7, further comprising the step of:
performing color correction on the image data based on the scanner specific color profile.

9. The method of claim 8, repeating the scanning, building, storing and performing color correction steps for each scanning cycle of the scanner.

10. The method of claim 7, wherein the color reference swatch and the image are contained in a target sheet.

11. The method of claim 7, wherein the color reference swatch is embedded in the bed of the scanner.

12. The method of claim 7, wherein the color reference swatch comprises a CMYK swatch.

13. The method of claim 7, wherein the scanner comprises a non-professional scanner.

14. A computer system, comprising:
a processor; and
color management software executable by the processor to retrieve a pre-stored scanner specific color profile and to automatically perform color correction for a scanner based on the scanner specific color profile.

15. The computer system of claim 14, wherein the color management software automatically performs color correction with each scanning cycle of the scanner.

16. The computer system of claim 14, wherein the scanner comprises a nonprofessional scanner.

17. A method, comprising the steps of:
retrieving a pre-stored scanner specific color profile for a scanner; and
automatically performing color correction for the scanner based on the scanner specific color profile.

18. The method of claim 17, wherein the pre-stored scanner specific color profile is stored by a manufacturer of the scanner.

19. The method of claim 17, wherein the scanner comprises a non-professional scanner.
